(19) United States
(12) Patent Application Publication
(10) Pub. No.: US 2013/0205284 A1
(43) Pub. Date: Aug. 8, 2013

(54) OWNERSHIP ACQUIRE POLICY SELECTION

(71) Applicants: Dhruva Chakrabarti, San Jose, CA (US); Prithviraj Banerjee, Palo Alto, CA (US); Hans Boehm, Palo Alto, CA (US); Pramod G. Joisha, Cupertino, CA (US); Robert Schreiber, Palo Alto, CA (US)

(72) Inventors: Dhruva Chakrabarti, San Jose, CA (US); Prithviraj Banerjee, Palo Alto, CA (US); Hans Boehm, Palo Alto, CA (US); Pramod G. Joisha, Cupertino, CA (US); Robert Schreiber, Palo Alto, CA (US)

(21) Appl. No.: 13/364,723

(22) Filed: Feb. 2, 2012

(51) Int. Cl. G06F 9/45

(52) U.S. Cl. 717/151

(57) ABSTRACT

There is provided a computer-implemented method of performing ownership acquire policy selection. The method includes compiling an atomic section to generate an instrumented executable. The instrumented executable is configured to generate a runtime abort graph describing a plurality of computer memory accesses made by the instrumented executable. The method also includes selecting each of a plurality of policies based on the runtime abort graph. The plurality of policies include a first policy and a second policy. The first policy is different from the second policy. The method further includes compiling the atomic section to generate a modified executable. The modified executable is configured to perform the computer memory accesses according to the selected policies.

### BACKGROUND

The use of atomic sections to synchronize shared memory accesses between multiple threads is an alternative to lock-based programming. Atomic sections raise the level of abstraction for a programmer. Using atomic sections, the programmer does not correlate shared data with a protecting lock. Consequently, with locks gone, deadlocks are gone too. A software transactional memory (STM) library implements atomic sections with synchronization between threads in order to maintain correctness of the data, and achieve a high degree of runtime performance. A runtime instance of an atomic section is usually referred to as a transaction. Due to memory conflicts, the transactions may abort, which reduces the efficiency of concurrent systems, and increases computational expenses. In the absence of conflicts, transactions successfully commit by exposing changes to other threads. To reduce aborts, an STM has the flexibility to choose from multiple policies governing conflict detection and resolution. These policies specify when a transaction takes exclusive control of a memory address. An eager policy detects conflicts early, usually by trying to acquire a lock on encountering a store to a shared memory location. While this policy has the advantage of detecting doomed transactions early, it results in holding locks for a longer duration, potentially reducing concurrency. On the other hand, a lazy policy detects conflicts late, usually by trying to acquire locks at commit time. While this policy has the advantage of holding locks for a shorter duration, it may result in wasted work since doomed transactions are detected late.

### BRIEF DESCRIPTION OF THE DRAWINGS

Certain exemplary embodiments are described in the following detailed description and in reference to the drawings, in which:

FIG. 1 is a block diagram of a system for performing ownership policy selection, in accordance with embodiments;

FIG. 2 is a flow diagram of a method for ownership acquire policy selection, in accordance with embodiments;

FIGS. 3A-3D represent timelines of abort scenarios, in accordance with embodiments;

FIG. 4 is a table that shows an example of an issue introduced through the use of different log policies, in accordance with embodiments;

FIG. 5 is a process flow diagram showing a computer-implemented method for propagating local solutions for policy selection throughout the application, in accordance with embodiments;

FIG. 6 is a block diagram of a system for selecting ownership acquire policies, in accordance with embodiments; and

FIG. 7 is a block diagram showing a tangible, machine-readable medium that stores code adapted to select ownership acquire policies, in accordance with embodiments.

### DETAILED DESCRIPTION

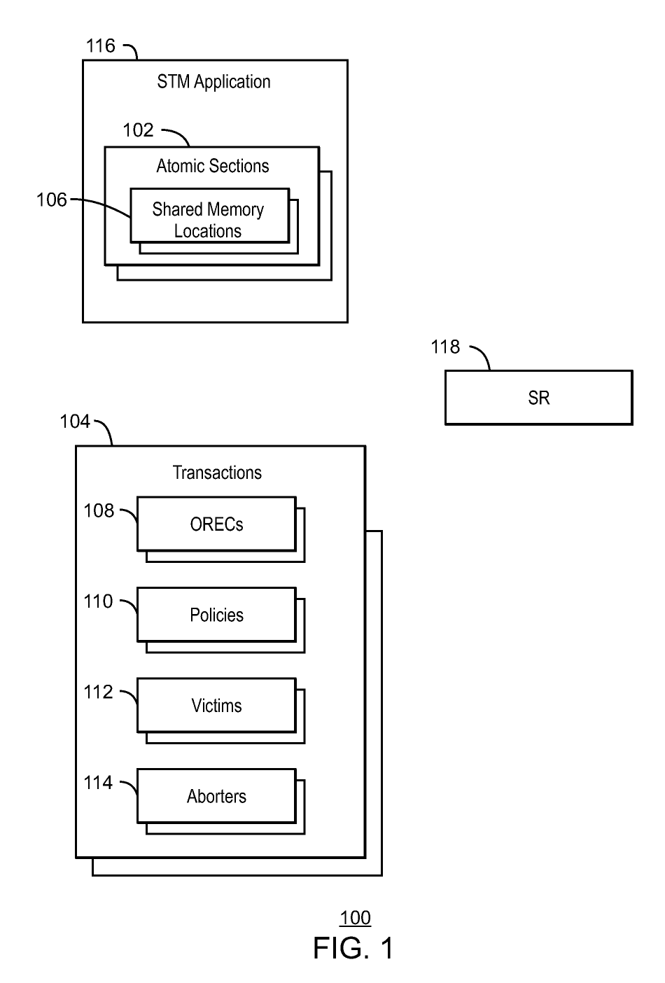

FIG. 1 is a block diagram of a system 100 for performing ownership policy selection, in accordance with embodiments. The system 100 includes atomic sections 102, transactions 104, a shared memory location 106, ownership records (ORECs) 108, policies 110, victims 112 of aborts, aborters 114, and static transactional memory references (SR) 118.

The atomic section 102 is a block of code that appears to execute in an indivisible manner. The STM applications 116 are multi-threaded software applications that use shared memory locations 106. Each STM application 116 includes one or more atomic sections 102.

A single transaction 104 is a dynamic execution instance of a compiled atomic section 102. In STM systems, functions and references can be transactional. A function is transactional if it can be transitively called from an atomic section. A reference is transactional if it executes under the control of a transactional memory system.

The SR 118 is a transactional load or store in the intermediate representation (IR) of an application 116. The intermediate representation of an application 116 refers to a translation of a program that is usable by a compiler for code generation. As referred to herein, a read or write memory reference is transactional, unless specified otherwise.

STM systems execute transactions 104, all of which use a shared memory, concurrently. Aborts may arise from memory conflicts between different transactions 104. Memory conflicts occur when two different transactions 104 reference, or appear to reference, the same shared memory location 106, and at least one of the references is a write.

A transaction 104 is implemented using the ORECs 108, policies 110, victims 112, and aborters 114. For every shared memory location 106 that the transaction 104 updates, a corresponding OREC 108 is acquired. In an embodiment, an OREC may just be a lock. The OREC 108 gives the transaction 104 exclusive control of the shared memory location 106. The transaction 104 may acquire the OREC 108 for a shared memory location 106 at a time specified by either an eager or lazy ownership acquire policy 110.

An abort involves two memory references: the victim 112 of the abort and the aborter 114. Typically, the transaction 104 aborts because execution of one transaction 104 cannot complete a load or store memory reference. In such a case, the memory reference in the transaction 104 that cannot complete is the victim 112. Further, the aborter 114 is the memory reference in another different transaction that prevented the victim 112 from proceeding.

A memory conflict may be detected, depending on the policy 110, either early or late during execution of the transaction 104. If the policy 110 is eager, the memory conflict is detected early. If the policy 110 is lazy, the memory conflict is detected late.

For a given atomic section 102, it is hard to tell in advance which policy performs better. With an eager policy, wasted work is avoided if the transaction 104 will abort, but on the downside, the lock is held longer, which potentially reduces concurrency. On the other hand, using a lazy policy delays lock acquisition, thereby producing a small contention window at commit time alone. However, the lazy policy can result in a lot of wasted work if the transaction 104 aborts.

Many STMs detect both read-write and write-write conflicts using the same policy. Some other STMs use mixed invalidation, whereby write-write conflicts are detected eagerly, and read-write conflicts are detected lazily. In one embodiment, a read transactional reference is handled the same way regardless of the policy. For a write reference, an eager policy indicates that the OREC 108 is acquired when the write is encountered at runtime. Under the eager policy, the conflict, if any, is detected when trying to acquire the OREC. A lazy policy indicates that the OREC 108 is acquired in the commit phase. According to this policy, any conflict is detected during the commit phase, i.e., late.

Embodiments of the present techniques automatically determine ownership acquire policies for selected memory references within an STM application 116. By determining different policies at the memory reference granularity, embodiments provide an automated way to reduce the number of aborts and wasted work. Information related to contention or abort patterns among memory references in prior executions may be used to determine policies 110 for each memory reference in a subsequent execution. Further, modifications to policies 110 may be propagated throughout an application 116 in a way that reduces the number of aborts.

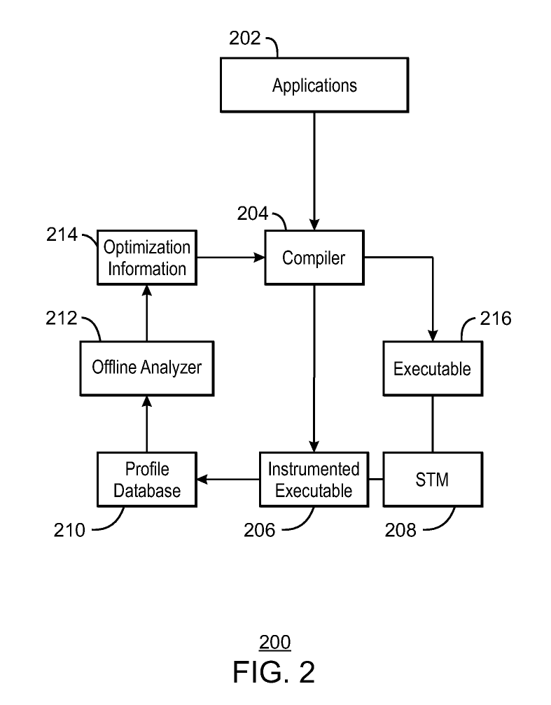

FIG. 2 is a flow diagram of a method 200 for ownership acquire policy selection, in accordance with embodiments. The method 200 may be performed in two phases. In a first phase, an STM application 202 is input to a compiler 204 that produces an instrumented executable 206. The instrumented executable 206, which links in appropriate routines from an STM 208, is run to generate a profile database 210. The STM 208 refers to runtime libraries for executing STM applications 202. An offline analyzer 212 produces optimization information 214 based on the profile database 210. The information in the profile database 210 and the optimization information 214 may be useful to a programmer, and the compiler 204, for tuning and optimization decisions regarding the STM application 202. The offline analyzer 212 also selects modified policies 110 for specific memory references.

In the second phase, the compiler 204 uses the optimization information 214 to generate an optimized executable 216. The optimized executable 216 may use a modified policy 110 for specific memory references. The profile database 210 may include a runtime abort graph (RAG), a list of readset (S_{rd}) and writeset (S_{wr}) sizes for references correlated with SRs 118, a list of source locations for SRs 118, a list of source locations for atomic sections 202, and a list of application specific information.

The list of source locations for SRs captures the location information for every SR. The list of source locations for atomic sections 202 captures the location information for every atomic section 202. The application specific information may include, for example, speculative readset (S_{rd}) and speculative writeset (S_{wr}) sizes for references correlated with SRs 118, the speculative sizes computed using policies different from those in the RAG. The optimization information 214 may include new optimized policies for specific memory references as computed by the offline analyzer 212.

The profile database 210 may include a runtime abort graph (RAG). A RAG is a directed graph, where each node corresponds to an SR. An edge captures an abort relationship and is directed from the aborter 114 to the victim 112. As stored in the profile database 210, a node may have the following annotations: αₒ: an id of the dynamically outermost enclosing atomic section 202 containing the SR; SR_{id}: an identifier of the SR; L: source code information of the SR; S_{rd}: average readset size of the outermost enclosing transaction at the time of the abort; S_{wr}: average writeset size of the outermost enclosing transaction at the time of the abort, A_{N}: the total number of aborts suffered by the victim 112.

Every node in the RAG may be keyed with the duple Nₖ=<αₒ,SR_{id}> that uniquely identifies an SR 118 in the context of the dynamically outermost enclosing atomic section 102. An edge is annotated with A_{E}, the total number of times the source node (i.e. the aborter) aborts the target node (i.e. the victim). For a given node, A_{N} is computed as the sum of A_{E} over all incoming edges. It is noted that S_{rd} and S_{wr} are not applicable if the node is not a victim 112.

Every atomic section 102 and SR 118 are assigned a program-wide unique identifier. This is achieved by using a to uniquely identify an atomic section 102 globally, β to uniquely identify a transactional function globally, and γ to uniquely identify a memory reference within the lexical scope of a transactional function. The duple SR_{id}=<β, γ> uniquely identifies a transactional reference within an entire application, which may include a number of transactions. The RAG may also include some source information as well, referred to as L=<λ,ρ,τ,>, where λ is the mangled name of the caller function and ρ and τ are the line and column numbers respectively.

In embodiments, only the outermost atomic section 102 is tracked for profiling purposes. If an SR 118 is contained within more than one distinct outermost atomic sections 102 (e.g. calls to a function containing the SR 118 from two distinct atomic sections), a separate node is added to the RAG for each such instance.

Embodiments identify conflict detection policies that improve performance. Pair-wise solutions are found at the reference level. This is accomplished in the context of improving performance across the application.

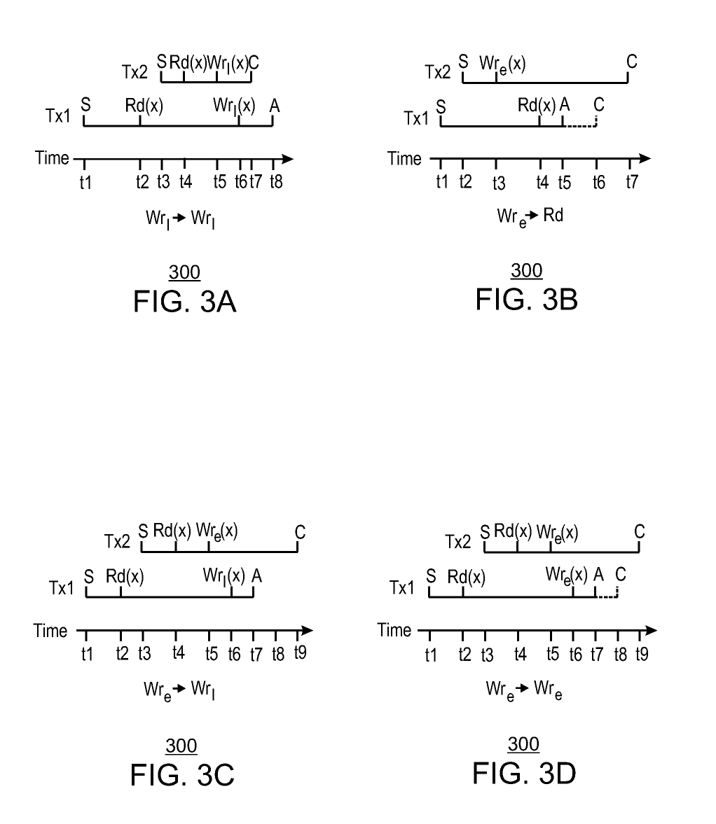

FIGS. 3A-3D represent timelines of abort scenarios, in accordance with embodiments. In each of the scenarios represented in FIGS. 3A-3D, the progression of two transactions 104 (Tx1 and Tx2) is shown on a time scale. In each scenario, Tx1 is the victim 112 and Tx2 is the aborter 114.

The performance penalty incurred by a transactional reference is determined by the aborts it suffers and the work that is wasted due to the abort. This penalty (Cₛᵣ) may be computed by defining the cost of an SR (or the corresponding RAG-node) as Cₛᵣ=A_{N}×(S_{rd}+S_{wr}), where A_{N}, S_{rd}, and S_{wr} respectively represent the abort count, the readset size, and the writeset size of the RAG-node. The cost of a RAG-edge is computed as Cₑ=A_{E}×(S_{rd}+S_{wr}), where A_{E}, S_{rd} and S_{wr} respectively represent the abort count of the edge, the readset size, and writeset size of the target RAG-node. The total cost of the RAG, Cₜₒₜ is the summation of Cₛᵣ over all nodes.

In embodiments, the SRs 118 for reads (Rd) may have a fixed policy, but the writes could follow either an eager (Wrₑ) or lazy (Wrₗ) policy. Accordingly, the various abort scenarios may be represented using the following shorthand: Aborter->Victim. For example, FIG. 3A represents an abort scenario, Wrₗ->Wrₗ, which indicates that a lazy write in one transaction is aborted by another lazy write in a different transaction. FIG. 3B represents an abort scenario, Wrₑ->Rd, which indicates that a read is aborted by an eager write from another transaction. FIG. 3C represents an abort scenario, Wrₑ->Wrₗ, which indicates that a lazy write is aborted by an eager write from another transaction. FIG. 3D represents an abort scenario, Wrₑ->Wrₑ, which indicates that an eager write is aborted by another eager write from a different transaction. As shown in FIGS. 3A-3D, the references, “S,” “C,” and “A” represent, respectively, the start, commit, and abort of a transaction 104. The dotted lines indicate where a commit is expected on the time scale, if the earlier abort can be avoided.

In FIG. 3A, both transactions, Tx1 and Tx2, use the lazy policy. The transactional write to shared memory location 106, x, in Tx1 happens at time, t6. The transactional write to the same location in Tx2 happens at t5. Tx2 commits before Tx1 at t7, which causes Tx1 to fail readset validation. Since Tx1 fails readset validation in the commit phase at t8, Tx1 aborts. In a case where Tx1 is a long-running transaction, with a large amount of wasted work, it may be beneficial for Tx1 to have its transactional write execute in an eager mode, so that it acquires ownership of x at t6 allowing it to successfully commit at t8. In this way, the cost to the victim may be reduced. The other three scenarios can be explained using similar logic, as shown below.

In FIG. 3B, transaction Tx1 executes a read to location x at t4 and transaction Tx2 executes an eager write to the same location at t3. The transaction, Tx1, aborts at t5 because at that time, transaction Tx2 has ownership of x. However, if Tx1 is a relatively short transaction (as suggested in FIG. 3B), it may be beneficial to run Tx2 in lazy mode, potentially allowing both transactions to commit successfully.

The scenario shown in FIG. 3C involves a lazy write by Tx1 and an eager write by Tx2. Because Tx2 acquires ownership of x at t5, Tx1 detects at t7 (during the commit phase) that the OREC 108 is held and aborts. Just by considering the cost of Tx1 in isolation, it may be beneficial to run Tx1 in eager mode and Tx2 in lazy mode, likely allowing Tx1 to commit.

FIG. 3D shows a scenario with eager writes in both transactions. Assuming Tx1 is relatively short, has a large number of aborts, and considering its cost in isolation, it may be beneficial to run Tx2 in lazy mode, allowing Tx1 to commit.

FIGS. 3A-3D show scenarios where changing the policies of one or more memory references may benefit runtime performance. A mechanism to specify a distinct policy for a specific memory reference is described below.

Each reference within a given transaction 104 may use either an eager or lazy policy, a scheme called reference level hybridization. In such an embodiment, a compiler or programmer interface may be provided for specifying policies at the memory reference level. In one embodiment, for a store to a shared memory reference within a transaction, a call to TxStore( ) signifies transactional handling of that store. Instead of, or in addition to, a store command, e.g., TxStore( ) a new interface may specify the policy for each memory reference, e.g., by introducing TxStore_eager( ) and TxStore_lazy( ) TxStore_eager indicates that the store memory reference should use the eager policy. TxStore_lazy indicates that the store memory reference should use the lazy policy. Using such an interface, regardless of the default policy in use by the atomic section 102, a different policy may be used for a specific transactional memory reference. When the compiler sees the TxStore( ) command, the default policy is used for that specific reference. The compiler also uses the specified policies according to the TxStore_eager( ) or TxStore_lazy( ) commands. Because transactional reads behave the same regardless of policies, a different interface to specify read policies may not be implemented.

The STM follows a log policy constraint. All transactional references, regardless of policy, use buffered updates. Accordingly, both eager and lazy transactional stores use the same kind of logging.

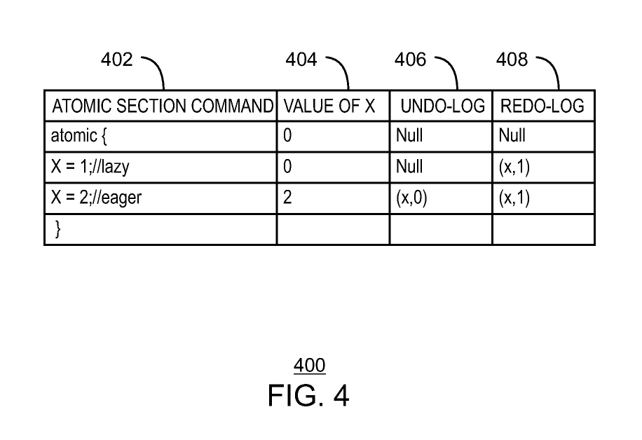

FIG. 4 is a table 400 that shows an example of an issue introduced through the use of different log policies, in accordance with embodiments. This example shows why the same logging policy is typically used for different conflict detection policies within the same transaction, and the issues faced if this is not done. An undo-log refers to a log where the old value of a shared transactional location is maintained as the latter is updated while holding the corresponding ownership record. If the transaction aborts later, its value is reverted from the undo-log. A redo-log is one where the new value is maintained until the commit phase when the shared memory location is updated with this new value while holding the corresponding ownership record. In this case, no copying is required if the transaction aborts.

Such an embodiment may include some constraints regarding read transactional reference. Since buffered updates are used for both eager and lazy policies, each read reference checks the writeset for the most recent value written by the current transaction 104. Validation may also performed by a read transactional reference. These changes result in the same read barrier for eager and lazy policies.

The table 400 includes four columns. The ATOMIC SECTION COMMAND 402 specifies each command line of an example atomic section 102. The VALUE OF X 404 specifies the value of a shared memory location 106, x, after the command is executed. The last two columns specify the contents of an example UNDO-LOG 406 and REDO-LOG 408, generated according to different log policies.

As shown, two updates to the shared location x occur in the example atomic section 102. A lazy policy is used for one reference, and an eager policy for the other. The UNDO-LOG 406 is maintained for eager writes and the REDO-LOG 408 is maintained for lazy writes according to their log policies. When the lazy write is executed, the entry for shared location x in the UNDO-LOG 406 is not updated. Instead, the new value is logged into the REDO-LOG 408. After executing the eager write, the OREC 108 for x is acquired and the location is directly modified. The old value of the shared location is stored in the UNDO-LOG 406. At the commit point, the STM implementation is, however, left with a problem because of the presence of both undo- and redo-log entries for shared location x. If the redo-log 408 is applied, the VALUE OF X 404 at the end of the transaction 104 will be 1, which is incorrect. The root cause is that the STM does not know the program order dependencies between entries in the UNDO-LOG 406 and REDO-LOG 408 for a given shared location. For this reason, in the absence of dependencies across entries in different logs 406, 408, the same logging policy has to be employed in a given transaction 104 in order to maintain correctness. Since a lazy transactional write does not acquire ownership of shared datum until commit time, direct updates for such writes would introduce a data race. Hence, buffered updates are used for both lazy and eager transactional writes using a redo log.

Consider the case when a write follows another write to the same location. When an eager write (Wrₑ) is followed by a lazy write (Wrₗ): Wrₑ will acquire a lock in a successful transactional write and buffer the new value into the writeset. When Wrₗ is executed, the corresponding lock is already held by the current transaction 104. In embodiments, this scenario is anticipated by the STM 100. The lazy write will buffer the latest new value into the writeset. In the commit phase, the STM 100 may be faced with a lazy writeset entry that has the corresponding lock held by the current transaction 104. The STM 100 anticipates such a scenario. Consequently, no additional lock acquire is necessary in the commit phase.

When a lazy write (Wrₗ) is followed by an eager write (Wrₑ) to the same memory location, the former will not acquire any lock, but just buffer the new value. The latter will acquire the lock and buffer the new value. During the commit phase, the implementation may be faced with a lazy writeset entry that has the corresponding lock held by the current transaction 104. This is similar to the previous scenario and is anticipated by the STM. Consequently, no additional lock acquire is necessary in the commit phase.

The above 2 scenarios hold regardless of the presence of false conflicts. For reference-level hybridization, consistency is maintained between multiple references within an atomic section 102. A data race is not created by the implementation of reference-level hybridization. This is because a location is protected by the same OREC 108 that is to be held by the thread trying to modify that location.

In one embodiment, the determination whether to modify the policy 110 may be based on the performance penalty of an abort under the initial policy versus the cost of executing the SR 118 according to the modified policy 110. The performance penalty incurred by an SR 118, alternately a RAG node, is determined by the number of resulting aborts, and the work that is wasted due to an abort. This penalty may be represented as shown in Equation 1:

Cₛᵣ=A_{N}×(S_{rd}+S_{wr}) (1)

where A_{N}, S_{rd}, and S_{wr} respectively represent the abort count, the readset size, and the writeset size of the SR 118. The cost of a RAG-edge may be represented as shown in Equation 2:

Cₑ=A_{E}×(S_{rd}+S_{wr}) (2)

where A_{E}, S_{rd} and S_{wr} respectively represent the abort count of the edge, the readset size, and writeset size of the target RAG-node. The total cost of the RAG, Cₜₒₜ is simply the summation of Cₛᵣ over all nodes.

Given a combination of policies for a victim and an aborter, the compiler may want to select a different combination with the aim of improving runtime performance. Since the policy 110 for any SR 118 may be either eager or lazy, and the SR 118 can be a read or a write, there are up to, 2⁴=16, potential abort scenarios. However, the aborter 114 cannot be a read, leaving only 2³=8 potential scenarios. In embodiments, there are no differences modeled between eager and lazy reads. As such, there remain just 6 potential abort scenarios that the system 100 may reduce. In embodiments, the compiler 204 may modify the policy 110 for the victim 112 and the aborter 114 as shown in Table 1.

TABLE 1

| Initial Policies | Modified Policies |
|---|---|
| Wrₗ -> Rd | No change |
| Wrₗ -> Wrₗ | Wrₗ -> Wrₑ |
| Wrₗ -> Wrₑ | No change |
| Wrₑ -> Rd | Wrₗ -> Rd |
| Wrₑ -> Wrₗ | Wrₗ -> Wrₑ |
| Wrₑ -> Wrₑ | Wrₗ -> Wrₑ |

Each of the potential abort scenarios is listed under the Initial Policies column. In the Modified Policies column, the policies 110 listed for the aborter 114 and the victim 112 are configured to reduce aborts for the victim SR 118. For example, in the second row of Table 1, the aborter 114 is a write performed with a lazy policy. The victim 112 is also a lazy write. As shown, the compiler 204 changes the policy of the victim 112 to an eager write. In this way, the aborts of the victim 112 in such scenarios may be reduced. It is noted that the Modified Policies of Table 1 are locally preferred solutions in the sense that they consider only the cost of the victim 112, but not the aborter. Further, the cost is determined in isolation from the rest of the victims 112 in the application 102.

Given a RAG and a table of locally preferred solutions, e.g., Table 1, embodiments select the policy 110 for every atomic section 102 that reduces the total cost of the RAG. In one embodiment, local solutions may be propagated throughout the entire application 116.

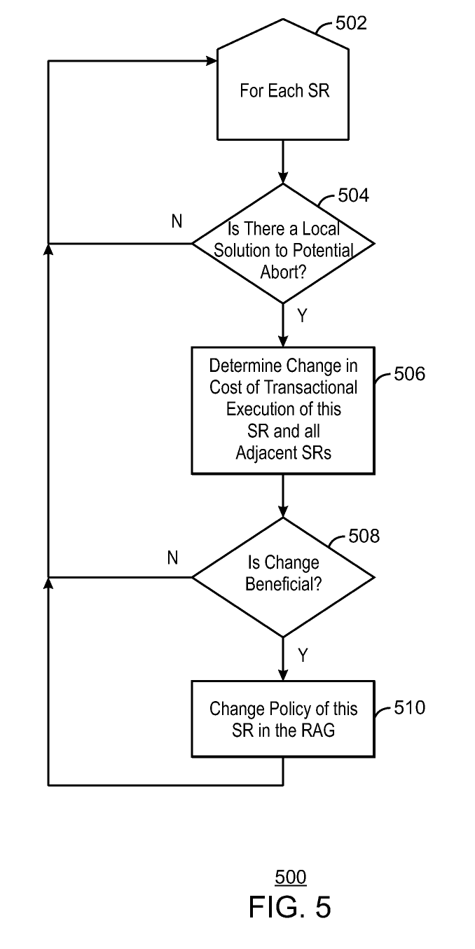

FIG. 5 is a process flow diagram showing a computer-implemented method 500 for propagating local solutions for policy selection throughout the application 116, in accordance with embodiments. It should be understood that the process flow diagram is not intended to indicate a particular order of execution. The method 500 may be performed by the offline analyzer 212 on all SRs 118 for an application 116.

The method may begin at block 502. Blocks 502-510 are repeated for each SR 118. At block 504, the analyzer 212 determines whether there is a locally preferred solution for a potential abort. If not, the next SR 118 is considered at block 502. If there is a local solution for an SR 118, at block 506, the change in cost of a transactional execution of this SR and all adjacent SRs is determined using this preferred solution. Given an SR 118, another SR is adjacent if these two have an edge between them in the RAG. At block 508, it is determined whether the change in cost is beneficial. If not, the next SR 118 is considered at block 502. If found beneficial, at block 510, the policy of this SR is changed in the RAG. Accordingly, the policy of this SR 118 is changed. In one embodiment, a compiler may use the RAG in the second phase to determine which policies to apply for each SR 118.

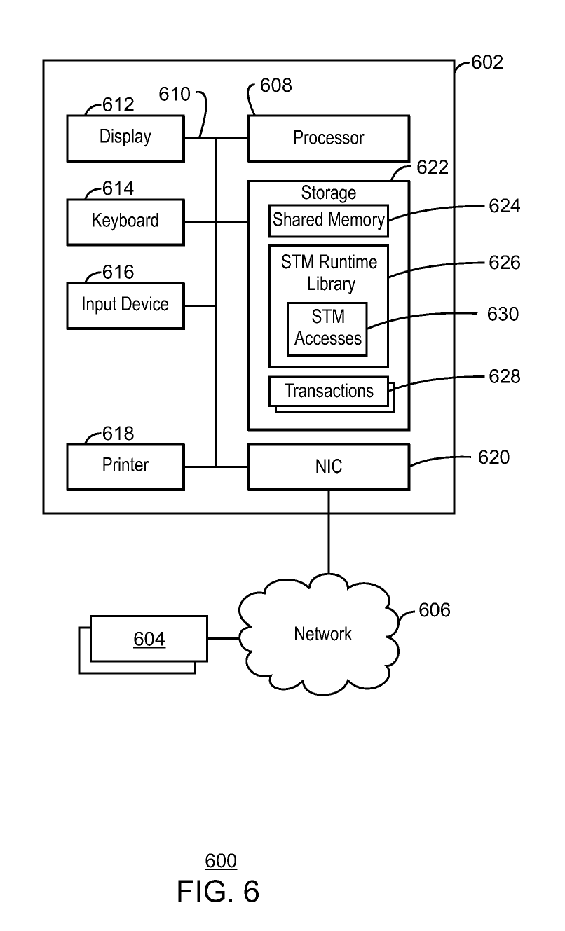

FIG. 6 is a block diagram of a system 600 for selecting ownership acquire policies, in accordance with embodiments. The functional blocks and devices shown in FIG. 6 may comprise hardware elements, software elements, or some combination of software and hardware. The hardware elements may include circuitry. The software elements may include computer code stored as machine-readable instructions on a non-transitory, computer-readable medium. Additionally, the functional blocks and devices of the system 600 are but one example of functional blocks and devices that may be implemented in an example. Specific functional blocks may be defined based on design considerations for a particular electronic device.

The system 600 may include a server 602, in communication with clients 604, over a network 606. The server 602 may include a processor 608, which may be connected through a bus 610 to a display 612, a keyboard 614, an input device 616, and an output device, such as a printer 618. The input devices 616 may include devices such as a mouse or touch screen. The server 602 may also be connected through the bus 610 to a network interface card 620. The network interface card 620 may connect the server 602 to the network 606. The network 606 may be a local area network, a wide area network, such as the Internet, or another network configuration. The network 606 may include routers, switches, modems, or any other kind of interface device used for interconnection. In one example, the network 606 may be the Internet.

The server 602 may have other units operatively coupled to the processor 612 through the bus 610. These units may include non-transitory, computer-readable storage media, such as storage 622. The storage 622 may include media for the long-term storage of operating software and data, such as hard drives. The storage 622 may also include other types of non-transitory, computer-readable media, such as read-only memory and random access memory. The storage 622 may include the machine readable instructions used in examples of the present techniques. In an example, the storage 622 may include a shared memory 624, a STM runtime library 626, and transactions 628. The shared memory 624 may be storage, such as RAM, that is shared among transactions 628 invoking routines from the STM runtime library 626. The transactions 628 are dynamic execution instance of compiled atomic sections 102. The transactions 628 invoke STM accesses 630 from the STM runtime library 626. The STM accesses 630 may be policy-specific or non-specific accesses to the shared memory 624 at the memory reference level. For example, the STM accesses 628 may include the TxStore( ), TxStore_eager( ) and TxStore_lazy( ) commands described with reference to FIGS. 3A-3D. The transaction 628 executes SRs 632. The SR 632 is the dynamic execution instance of the STM accesses 630. Each SR 632 executes a memory reference according to a specific policy. One transaction 628 may execute each memory references according to a different policy.

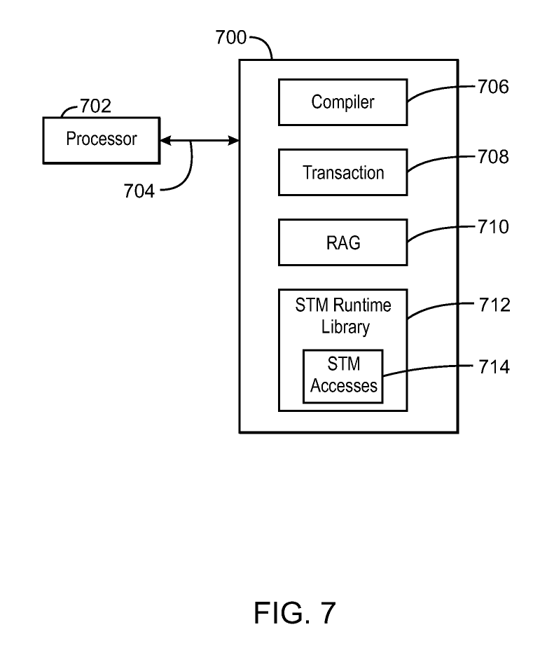

FIG. 7 is a block diagram showing a tangible, non-transitory, machine-readable medium that stores code adapted to select ownership acquire policies, in accordance with embodiments. The machine-readable medium is generally referred to by the reference number 700. The machine-readable medium 700 may correspond to any typical storage device that stores computer-implemented instructions, such as programming code or the like. Moreover, the machine-readable medium 700 may be included in the storage 622 shown in FIG. 6. When read and executed by a processor 702, the instructions stored on the machine-readable medium 700 are adapted to cause the processor 702 to perform ownership acquire policy selection. The medium 700 includes a compiler 706, transaction 708, RAG 710, and STM runtime library 712. The compiler 706 may generate transactions 708 based on the RAG 710 generated by an instrumented executable 206. To reduce overhead, transactions 708 are generated that perform memory accesses by invoking STM accesses 714 from the STM runtime library 712. The STM accesses 714 perform memory accesses with a specific policy at the memory reference and transaction levels.

What is claimed is:

1. A method performed by a compiler module configured to direct a processing unit to select ownership acquire policies, the method comprising:
compiling an atomic section to generate an instrumented executable, wherein the instrumented executable is configured to generate a runtime abort graph describing a plurality of computer memory accesses performed by the instrumented executable;
selecting each of a plurality of policies for each of the computer memory accesses within the atomic section based on the runtime abort graph, wherein the policies comprise a first policy and a second policy, and wherein the first policy is different from the second policy; and
compiling the atomic section to generate a modified executable, wherein the modified executable is configured to perform the computer memory accesses according to the selected policies.

2. The method recited by claim 1, wherein the computer memory accesses comprise a write access and a read access, and wherein the selected policy for the write memory access comprises either an eager policy or a lazy policy.

3. The method recited by claim 2, wherein a software transactional memory library supports an interface for performing the computer memory accesses according to the selected policies, and wherein the interface uses write buffering for the write access.

4. The method recited by claim 1, wherein selecting the policies is based on improving application run-time performance of a transaction comprising the atomic section, and wherein a total estimated overhead of an execution of the transaction using the selected policies, is reduced.

5. The method recited by claim 4, wherein the total estimated overhead of the execution is modeled as an estimate of work completed within the transaction before an abort occurs.

6. The method recited by claim 4, wherein the policies are selected based on:
a previous policy for each of the computer memory accesses;
a locally preferred policy obtained from the runtime abort graph; and
the total estimated overhead of the execution of the transaction using the selected policies.

7. The method recited by claim 6, wherein the computer memory accesses comprise a victim memory access and an aborter memory access, wherein the victim memory access is associated with the aborter memory access, and wherein selecting a policy for the victim memory access is based on an analysis of the runtime abort graph, and wherein the selected policy for the victim memory access is based on an estimated reduction of overhead of transactional execution of the victim memory access.

8. The method recited by claim 7, wherein the selected policy for the victim memory access comprises a locally preferred policy, and wherein an estimated total overhead of transactional execution over an entirety of the runtime abort graph is computed, and wherein if the estimated total overhead of transactional execution over an entirety of the runtime abort graph is reduced, the locally preferred policy is accepted and the runtime abort graph is updated to reflect a propagation of a change in policies.

9. A computer system for selecting ownership acquire policies, the computer system comprising:
a processor that is adapted to execute stored instructions; and
a memory device that stores instructions, the memory device comprising:
a software transactional memory runtime library comprising:
computer-implemented code adapted to perform a first computer memory access according to a first policy;
computer-implemented code adapted to perform a second computer memory access according to a second policy;
computer-implemented code adapted to execute the first computer memory access according to the first policy as specified within an atomic section during an execution of a transaction comprising the atomic section; and
computer-implemented code adapted to execute the second computer memory access according to the second policy as specified within the atomic section during the execution.

10. The computer system recited by claim 9, wherein the first policy is a lazy policy and the second policy is an eager policy.

11. The computer system recited by claim 9, wherein the runtime library comprises computer-implemented code adapted to perform a third computer memory access according to a default policy for the atomic section.

12. The computer system recited by claim 11, wherein the memory device comprises computer-implemented code adapted to execute the third computer memory access according to the default policy for the atomic section.

13. The computer system recited by claim 9, wherein the memory device comprises:
computer-implemented code adapted to compile the atomic section to generate an instrumented executable, wherein the instrumented executable is configured to generate a runtime abort graph describing a plurality of computer memory accesses made by the instrumented executable;
computer-implemented code adapted to select each of a plurality of policies for each of the computer memory accesses within the atomic section based on the runtime abort graph, wherein the policies comprise the first policy and the second policy, and wherein the first policy is different from the second policy; and
computer-implemented code adapted to compile the atomic section to generate a modified executable, wherein the modified executable is configured to perform the computer memory accesses according to the selected policies.

14. The computer system recited by claim 13, wherein the computer-implemented code adapted to compile the atomic section to generate the modified executable, comprises computer-implemented code adapted to invoke, based on the selected policies, both of:
the computer-implemented code adapted to perform the first computer memory access according to the first policy; and
the computer-implemented code adapted to perform the second computer memory access according to the second policy;

15. The computer system recited by claim 14, wherein the computer memory accesses comprise a write access and a read access, wherein computer-implemented code adapted to perform the write access comprises computer-implemented code adapted to use write buffering.

16. The computer system recited by claim 13, wherein the computer-implemented code to select the policies is based on improving application run-time performance of an execution of a transaction comprising the modified executable, and wherein a total estimated overhead of the execution is reduced by the selected policies.

17. The computer system recited by claim 16, wherein the total estimated overhead of the execution is modeled as an estimate of work completed within the transaction before an abort occurs.

18. A tangible, non-transitory, machine-readable medium that stores machine-readable instructions executable by a processor to perform ownership acquire policy selection, the tangible, non-transitory, machine-readable medium comprising:
machine-readable instructions that, when executed by the processor, compile an atomic section to generate an instrumented executable, wherein the instrumented executable is configured to generate a runtime abort graph describing a plurality of computer memory accesses made by the instrumented executable;
machine-readable instructions that, when executed by the processor, select each of a plurality of policies for each of the computer memory accesses, based on the runtime abort graph, wherein the policies comprise an eager policy and a lazy policy; and
machine-readable instructions that, when executed by the processor, compile the atomic section to generate a modified executable, wherein the modified executable is configured to perform the computer memory accesses according to the selected policies, wherein the modified executable is configured to invoke, from a software transactional runtime library, both of:
machine-readable instructions that, when executed by the processor, perform a first computer memory access according to the eager policy; and
machine-readable instructions that, when executed by the processor, perform a second computer memory access according to the lazy policy.

19. The tangible, machine-readable medium recited by claim 18, wherein the computer memory accesses comprise a read memory access and a write memory access, and comprising machine-readable instructions that, when executed by the processor, use write buffering for the write memory access.

20. The tangible, machine-readable medium recited by claim 18, wherein the machine-readable instructions that, when executed by the processor, select the policies is based on improving application run-time performance of the transaction, and wherein a total estimated overhead of the execution is reduced by the selected policies, wherein the total estimated overhead of the execution is modeled as an estimate of work completed within the transaction before an abort occurs.
